(19) United States
(12) Patent Application Publication
(10) Pub. No.: US 2026/0099491 A1
(43) Pub. Date: Apr. 9, 2026

(54) End-to-end SQL generation

(71) Applicant: Distyl AI, Inc., San Francisco, CA (US)

(72) Inventors: Karime Maamari, Los Angeles, CA (US); Yonas Tesfaye, Redwood City, CA (US); Amine Mhedhbi, Outremont (CA)

(21) Appl. No.: 19/366,345

(22) Filed: Oct. 22, 2025

Related U.S. Application Data
(63) Continuation of application No. PCT/US2025/050087, filed on Oct. 8, 2025.
(60) Provisional application No. 63/704,637, filed on Oct. 8, 2024.

(51) Int. Cl. G06F 16/2452; G06F 16/242

(52) U.S. Cl. CPC G06F 16/24522; G06F 16/243

(57) ABSTRACT

Embodiments include systems and methods for user authentication using behavioral biometrics. In some embodiments, the method includes collecting raw behavioral data regarding user interactions with a device; extracting a plurality of features from the raw behavioral data; mapping the features to a plurality of mathematical spaces; generating, based on the mapped features, a unified behavioral profile; and determining, based on the unified behavioral profile, an authentication decision for a user of the device.

### CROSS-REFERENCE TO RELATED APPLICATIONS

The present application is a continuation of International (PCT) Patent Application No. PCT/US2025/050087, filed internationally on Oct. 8, 2025, and claims the benefit of and priority to U.S. Provisional Application No. 63/704,637, filed on Oct. 8, 2024, the entire disclosure of which is hereby incorporated by reference as if set forth in its entirety herein.

### TECHNICAL FIELD

Embodiments described herein generally relate to systems and methods for structured language query generation and, more particularly but not exclusively, to systems and methods for end-to-end structured language query generation.

### BACKGROUND

The demand for democratized access to data has increased substantially in recent years, fueled by the pervasive need for data-driven decision making across various domains such as finance, healthcare, manufacturing, logistics, and consumer technology. In modern enterprises, the ability to query and analyze large volumes of structured data is often critical for gaining business insights, monitoring operations, and ensuring compliance with regulatory requirements. However, traditional approaches to data access and analytics typically require specialized expertise in database management systems (DBMS) and proficiency in structured languages such as Structured Query Language (SQL). This technical barrier excludes a wide range of potential users, such as business analysts, managers, and domain experts, who may lack the requisite experience but nevertheless require direct access to data to perform their roles effectively.

To overcome this limitation, text-to-SQL systems have been developed to automatically translate natural language into executable SQL (and/or other structured language) queries. Such systems have expanded access to data analytics by allowing non-technical users to analyze data from databases without requiring specialized database knowledge.

Current text-to-SQL solutions, however, predominantly employ rule-based techniques, template-driven approaches, or semantic parsers. This causes current solutions to be rigid in structure and struggle with complex and varied natural language inputs. For instance, some approaches attempt to simplify query generation through syntax tree parsing and intermediate representations. Although effective for limited query classes, such approaches often fail to capture the contextual nuances of user intent, resulting in inaccuracies, inefficiencies, and an inability to handle complex or domain-specific queries. Moreover, such approaches typically require significant manual engineering effort to define templates, rules, or grammars for each deployment environment, limiting scalability across domains.

Recent advancements in artificial intelligence, particularly the emergence of large language models (LLMs), provide new opportunities for text-to-SQL systems to eliminate past limitations. LLM-based approaches can leverage deep contextual understanding and generative capabilities to map natural language queries to structured language queries with improved accuracy and generalization.

Accordingly, there exists a need for improved methods and systems for end-to-end structured language query generation.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In some aspects, the techniques described herein relate to a computer-implemented method for structured language query generation, including: generating a knowledge set based on at least one query log and at least one domain-specific document; receiving a natural language query for a database; retrieving data relevant to the natural language query from the knowledge set; generating, based on the relevant data and the natural language query, a candidate structured language query using a machine learning model; and presenting the candidate structured language query for execution against the database.

In some embodiments, the candidate structured language query includes a SQL query.

In some embodiments, the knowledge set includes generation instructions, sub-expressions representing structured language queries at the query log, and a schema representation indicating the structure of the database.

In some embodiments, the generating the knowledge set includes: retrieving the structured language queries from the query log; reformatting the structured language queries into a sketch based on common table expressions; and decomposing the sketch into sub-queries; and generating the sub-expressions based on the sub-queries.

In some embodiments, the generation instructions and sub-expressions are partitioned in the knowledge set according to user intent.

In some embodiments, the schema representation indicates the structure of the database using at least one of a table name, column name, column type, or column data sample.

In some embodiments, the retrieving the relevant data includes: reformatting the natural language query in a canonical form; identifying a user intent of the natural language query; identifying relevant generation instructions and sub-expressions from the knowledge set based on the user intent; and identifying irrelevant elements of the schema representation using a second machine learning model.

In some embodiments, the generating the candidate structured language query includes constructing, based on the natural language query and the relevant data, a chain-of-thought reasoning plan including at least one pseudo-SQL statement.

In some embodiments, the machine learning model includes a large language model configured to receive the natural language query and the relevant data as input.

In some embodiments, the computer-implemented method further includes: receiving feedback regarding the execution of the candidate structured language query; and updating the knowledge set based on the feedback; and updating the candidate structured language query based on the updated knowledge set.

In some embodiments, the feedback includes at least one of user feedback or feedback from an evaluation model.

In another aspect, the techniques described herein relate to a system for structured language query generation, including: memory storing instructions; and a processor executing the instructions to perform the steps of: generating a knowledge set based on at least one query log and at least one domain-specific document; receiving a natural language query for a database; retrieving data relevant to the natural language query from the knowledge set; generating, based on the relevant data and the natural language query, a candidate structured language query using a machine learning model; and presenting the candidate structured language query for execution against the database.

In some embodiments, the candidate structured language query includes a SQL query.

In some embodiments, the knowledge set includes generation instructions, sub-expressions representing structured language queries at the query log, and a schema representation indicating the structure of the database.

In some embodiments, the generating the knowledge set includes: retrieving the structured language queries from the query log; reformatting the structured language queries into a sketch based on common table expressions; and decomposing the sketch into sub-queries; and generating the sub-expressions based on the sub-queries.

In some embodiments, the retrieving the relevant data includes: reformatting the natural language query in a canonical form; identifying a user intent of the natural language query; identifying relevant generation instructions and sub-expressions from the knowledge set based on the user intent; and identifying irrelevant elements of the schema representation using a second machine learning model.

In some embodiments, the generating the candidate structured language query includes constructing, based on the natural language query and the relevant data, a chain-of-thought reasoning plan including at least one pseudo-SQL statement.

In some embodiments, the machine learning model includes a large language model configured to receive the natural language query and the relevant data as input.

In some embodiments, the processor is further configured to perform the steps of: receiving feedback regarding the execution of the candidate structured language query; and updating the knowledge set based on the feedback; and updating the candidate structured language query based on the updated knowledge set.

In yet another aspect, the techniques described herein relate to a computer program product embodied in a non-transitory computer readable storage medium and including computer instructions for: generating a knowledge set based on at least one query log and at least one domain-specific document; receiving a natural language query for a database; retrieving data relevant to the natural language query from the knowledge set; generating, based on the relevant data and the natural language query, a candidate structured language query using a machine learning model; and presenting the candidate structured language query for execution against the database.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for end-to-end structured language query generation in accordance with one embodiment.

FIG. 2 illustrates a flowchart of a method for end-to-end structured language query generation in accordance with one embodiment.

FIG. 3 illustrates a knowledge set for end-to-end structured language query generation in accordance with one embodiment.

FIG. 4 illustrates a command-line interface for end-to-end structured language query generation in accordance with one embodiment.

FIG. 5 illustrates a structured language query in accordance with one embodiment.

FIG. 6 illustrates a multi-stage pipeline for end-to-end structured language query generation in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

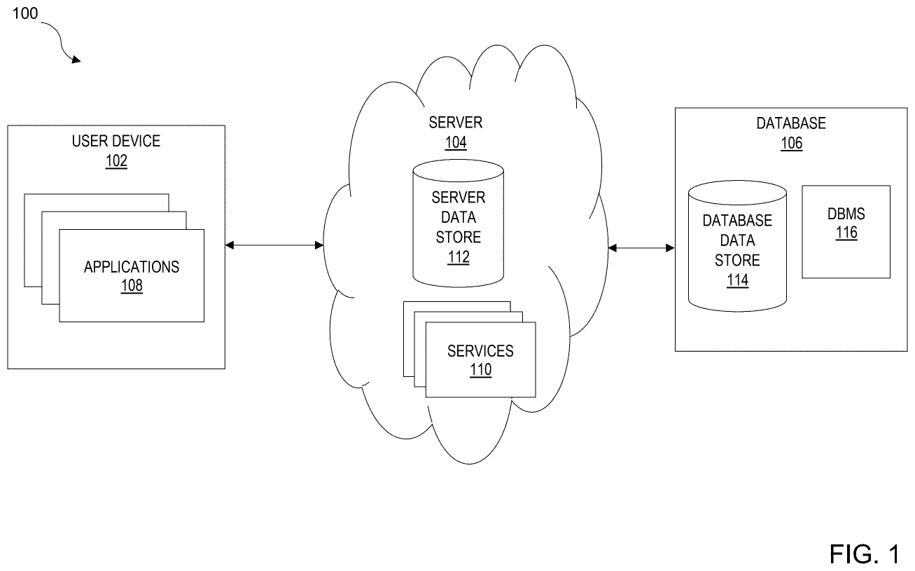

FIG. 1 illustrates a system 100 for end-to-end structured language query generation in accordance with one embodiment. The system 100 may include any number of components for performing operations related to structured language query generation. As shown, for example, the system 100 may include a user device 102, a server 104, and a database 106. Although one of each of the user device 102, the server 104, and the database 106 are shown, it is to be appreciated that the system 100 may include any suitable number of components.

The user device 102 may include any type or form of device that a user can interact with to perform one or more functions or operations. Exemplary user devices may include, but are not limited to, smartphones, tablets, personal computers (e.g., laptops, desktops, etc.), smartwatches, fitness trackers, and/or television sets.

As shown, the user device 102 may execute one or more applications 108. The user device 102 may include any number of processing and/or memory units to execute and store the applications 108. The applications 108 may include any suitable type of application, such as containerized applications, web programs, deployment tools, security services, data services, database applications, and/or data analytics platforms. The applications 108 may allow the user to interact with data and/or services from remote systems, such as data and/or services provided by the server 104 and/or database 106. The applications 108 may provide user interfaces for interacting with the data and/or services.

The server 104 may be configured to provide one or more services 110 to external devices and/or systems, such as the user device 102. The server 104 may include any suitable type or form of server, such as a web server, a database server, an application server, and/or a virtualization server. The server 104 may be configured to process data and/or interpret, execute, and/or direct execution of one or more of the instructions, processes, and/or operations described herein. For example, the server 104 may perform various operations related to end-to-end structured language query generation.

The services 110 may include any suitable type of service provided by the server 104, such as security services, authentication services, communication services, web services, database services, storage services, knowledge management services, and/or data analytics services.

The server 104 may include a server data store 112 for storing data and/or instructions, such as data related to end-to-end structured language query generation. The server data store 112 may include one or more data storage media, devices, or configurations and may employ any type, form, and combination of data storage media and/or device. For example, the server data store 112 may include, but is not limited to, any combination of the non-volatile media and/or volatile media described herein. Electronic data, including data described herein, may be temporarily and/or permanently stored at the server data store 112. For example, computer-executable instructions configured to direct server processing units to perform any of the operations described herein may be stored within the server data store 112. In some examples, the server data store 112 may store a knowledge set used for structured language query generation.

The database 106 may include any suitable database for managing data at a database data store 114, such as a relational database, a distributed key-value store, a document-oriented database, and/or a graph database. The database 106 may manage data for a particular domain and/or business entity, such as a healthcare center and/or financial institution. The database 106 may manage structured data using a database management system (DBMS) 116. The DBMS 116 may execute various operations for managing data at the database data store 114. For example, the DBMS 116 may receive structured language queries (e.g., SQL commands) from a requesting entity (e.g., the user device 102), parse the queries, and return results to the requesting entity. In some examples, the DBMS 116 may provide various services for the database 106, such as transaction management services, concurrency control services, indexing services, data integrity services, and/or optimization services.

In a traditional configuration, the structured language queries may be directly received from a user, such as a user of the user device 102. For example, the user may directly input a SQL command at the user device 102 (e.g., via the applications 108). The database 106 may receive the SQL command, parse the command using the DBMS 116, and return a result set based on data from the database data store 114. The user may view the result set using a user interface presented at the user device 102.

In some embodiments, the system 100 may generate structured language queries based on natural language inputs (e.g., natural language queries). For example, the user may input a natural language query at the user device 102. The user device 102 may send the natural language query to the server 104. The server 104 may generate a candidate structured language query based on the natural language query (e.g., via the services 110). The server 104 may send the candidate structured language query to the database 106, which may process the query and return a result set based on data from the database data store 114.

Further details regarding the structured language query generation are described herein.

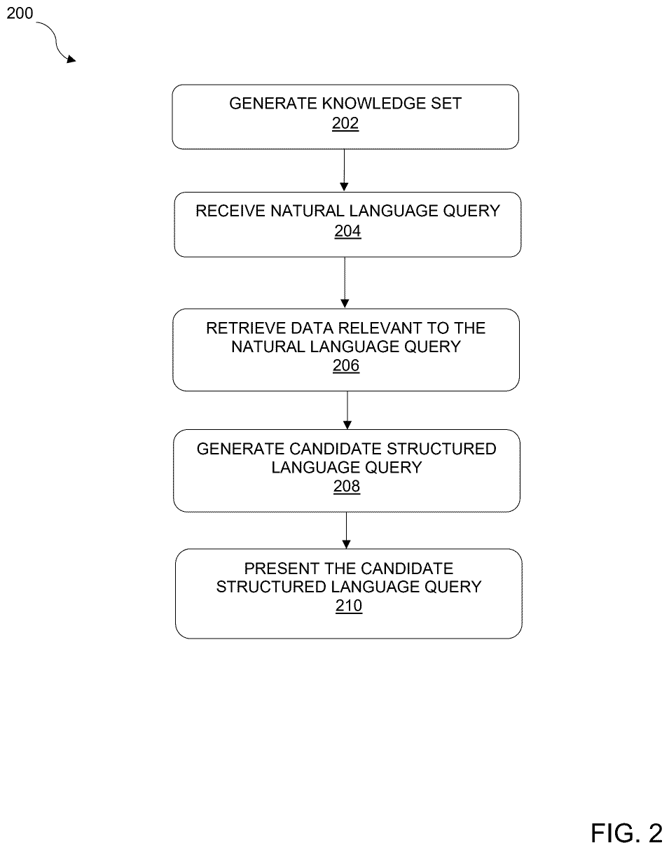

FIG. 2 illustrates a flowchart of a method 200 for end-to-end structured language query generation in accordance with one embodiment. While FIG. 2 shows illustrative operations according to one embodiment, other embodiments may omit, add to, reorder, and/or modify any of the operations shown in FIG. 2. Moreover, each of the operations depicted in FIG. 2 may be performed in any of the ways described herein. The operations shown in FIG. 2 may be performed by any of the illustrative systems described herein, such as the system 100. For example, any of the operations may be performed at the user device 102 and/or server 104.

At operation 202, the method 200 may include generating a knowledge set based on at least one query log and at least one domain-specific document. The knowledge set may be stored at a suitable data store for future processing, such as the database data store 114.

The query log may include records of previously executed structured language queries (e.g., SQL queries) and/or metadata regarding the executed structured language queries. The metadata may include any suitable type of metadata, such as timestamps, user identifiers, execution costs, error codes, and/or performance metrics.

The domain-specific documents may include documents that correspond to a particular domain, such as technical manuals, data dictionaries, schema documentation, regulatory filings, compliance guidelines, business glossaries, scientific publications, and/or training materials. The domain-specific documents may correspond to any suitable domain, such as financial domains, healthcare domains, manufacturing domains, retail domains, energy domains, transportation domains, computing domains, research domains, and/or education domains.

The domain-specific documents may include and/or define terminology or practices that are specific to the corresponding domain. For example, in the financial domain, the domain-specific documents may specify standardized definitions of metrics such as “quarter-over-quarter growth” or “return per viewer.” In the healthcare domain, the domain-specific documents may define coding standards, medical terminologies, and/or reporting requirements.

The knowledge set may be any suitable structured set of information relevant to generating structured language queries for execution against a database, such as the database 106. The knowledge set may serve as a repository of contextual information for query generation. For example, the knowledge set may include generation instructions, sub-expressions representing structured language queries, and/or a schema representation indicating the structure of the database.

The generation instructions of the knowledge set may include instructions indicating how to interpret natural language inputs and convert them to structured language queries. The generation instructions may be derived from exemplary queries (e.g., from the query log) and the domain-specific document. The generation instructions may be represented in natural language and/or structured language sub-expressions.

The sub-expressions of the knowledge set may represent various structured language queries in a decomposed format. The sub-expressions may be derived from structured language queries, such as queries from the query log and/or queries received directly from domain experts. To generate the sub-expressions, the received queries may be reformatted into a common table expression (CTE)-based sketch, which provides an intermediate abstraction that separates complex queries into modular, reusable components. Each reformatted query may be decomposed into subqueries based on WITH clauses. Each subquery may then be broken down into sub-expressions based on inner clauses, such as SELECT clauses, WHERE conditions, GROUP BY statements, JOIN operations, and/or ORDER BY directives.

In some embodiments, the sub-expressions may be augmented with natural language annotations that describe the meaning or purpose of each component. The annotations may provide additional information needed to interpret ambiguous or domain-specific queries. For example, a JOIN clause may be annotated as “combine customer and orders tables by matching customer ID.” The annotations may be generated automatically (e.g., using LLMs) and/or received from domain experts.

The schema representation of the knowledge set may provide an outline of the structure of the database. The schema representation may be extracted directly from the database and/or obtained from database documentation. The schema representation may include various fields for representing the database structure, such as table names, column names, column types (e.g., categorial, numerical, textual, temporal, etc.), column descriptions (e.g., business contexts, semantic meanings, etc.), and/or representative column data samples.

In some embodiments, the schema representation may be supplemented with contextual annotations. For example, categorial column names may be annotated with domain-specific terminology, abbreviations, and/or synonyms frequently encountered in natural language inputs. Numeric column names may be annotated with units of measurement (e.g., dollars, percentages, milliseconds, etc.). Temporal column names may be annotated with business semantics, such as fiscal quarters or academic terms.

In some embodiments, data at the knowledge set may be organized based on at least one characteristic, such as domain, user intent, complexity level, time of use or generation, source type, and/or schema structure. The data may be partitioned by the characteristic. For example, the generation instructions and/or sub-expressions may be partitioned by user intent. The user intent may represent the high-level task requested by a user, such as filtering, aggregation, comparison across time periods, and/or ranking.

At operation 204, the method 200 may include receiving a natural language query for a database. The natural language query may include any query expressed in ordinary human language. For example, an exemplary natural language query may be “show me all sales from last month.” The natural language query may include terminology or phrases that are specific to a particular domain. The natural language query may be sent from any suitable system and/or device, such as the user device 102. A user may input the natural language query via a user interface (e.g., a command line interface), application, and/or service executing at the system and/or device.

At operation 206, the method 200 may include retrieving data relevant to the natural language query from the knowledge set. For example, the relevant data may include relevant generation instructions, relevant sub-expressions, and/or relevant elements of the schema representations.

In some embodiments, the natural language query may be reformatted into a canonical form (e.g., before retrieving the relevant data). Reformatting may include operations such as normalizing terminology, resolving synonyms, standardizing tense or phrasing, and/or removing extraneous words or noise. The reformatting may ensure that queries with similar meaning but different linguistic phrasing are treated consistently during downstream processing.

The relevant data may be identified using any suitable filtering technique. For example, the relevant data may be identified based on a similarity search. The natural language query may be analyzed to determine at least one characteristic of the natural language query, such as user intent. The entries in the knowledge set (e.g., the generation instructions and/or sub-expressions) may be ranked based on similarity to the natural language query according to the characteristic. Entries with sufficiently high similarity (e.g., having a similarity score exceeding a threshold) may be selected as relevant data. For example, entries with a user intent sufficiently similar to the user intent of the natural language query may be selected as relevant data.

In some embodiments, the relevant data may be retrieved from the knowledge set in a particular order. For example, the relevant sub-expressions may be retrieved first, followed by the relevant generation instructions, and finally the relevant elements of the schema representation. In some embodiments, the generation instructions at the knowledge set may be ranked based on similarity using the relevant sub-expressions.

In some embodiments, at least one machine learning model may be used to identify the relevant data. For example, an LLM may be configured to identify and remove irrelevant elements of the schema representation, such as irrelevant tables or columns. The function of the LLM may be to output a minimally sized schema representation that is still sufficient to answer the natural language query. A minimum element quota may be enforced to prevent over-pruning.

In some embodiments, the filtering techniques described above may be applied only if the size of the knowledge set (and/or sections of the knowledge set) exceeds a predetermined threshold. For example, the entire schema representation may be preserved if the size of the schema representation does not exceed a predetermined threshold.

At operation 208, the method 200 may include generating, based on the relevant data and the natural language query, a candidate structured language query using a machine learning model.

The candidate structured language query may be generated using any suitable technique. For example, in some embodiments, a reasoning plan may be constructed from the natural language query and/or the relevant data from the knowledge set. The reasoning plan may be a chain-of-thought (CoT) reasoning plan that outlines a sequence of operations for generating the structured language query. In this manner, the generation process may be decomposed into multiple intermediate steps. In some embodiments, the CoT reasoning plan may be represented as a directed sequence or graph indicating dependencies between operations. For example, an aggregation step may depend on a prior filtering step. Other exemplary types of reasoning plans may include tree-of-thoughts reasoning plans and/or program-of-thoughts reasoning plans.

In some embodiments, the reasoning plan may be augmented with pseudo-structured language query examples (e.g., pseudo-SQL statements derived from the knowledge set). The examples may include intermediate representations of structured language queries that capture high-level structure, operations, and/or relationships. For example, the examples may include partial query sketches, templated sub-expressions, and/or illustrative CTE structures.

In some embodiments, the candidate structured language query may be generated using a machine learning model, such as an LLM. The model may be configured to receive the natural language query, the relevant data, and/or the reasoning plan as inputs and output the candidate structured language query. In some embodiments, the model may output multiple candidate queries, which may be ranked according to predefined criteria, such as syntactic validity, semantic plausibility, and/or estimated execution efficiency.

At operation 210, the method 200 may include presenting the candidate structured language query for execution against the database. The candidate structured language query may be parsed and executed by a database management system, such as the DBMS 116. The resulting execution may be tailored for the domain corresponding to the database. For example, the execution may be tailored for patients records or clinical trial data at a healthcare database.

While the method 200 is shown as including operations 202 to 210, it is to be appreciated that the method 200 may include any number of additional and/or alternative operations. For example, in some embodiments, the candidate structured language query may be updated based on feedback after executing the query. The feedback may include any suitable type of feedback, such as execution error reports (e.g., reports from the database management system), model-based assessments, and/or user feedback.

The execution error reports may indicate parsing errors (e.g., unrecognized keywords, unmatched parentheses, and/or improper clause ordering) and/or runtime errors (e.g., applying operations to incompatible data types). The execution error reports may include structured descriptions of the errors, such as natural language descriptions. The error reports may be provided by the database management system (e.g., after parsing the candidate structured language query).

The model-based assessments may be generated from a machine learning model configured to determine the correctness of the candidate structured language query using predefined criteria. For example, the machine learning model may detect whether the candidate structured language query aligns with the detected user intent, references non-existent schema elements, contains logically inconsistent conditions, and/or is unlikely to return meaningful results.

In some embodiments, the feedback may be provided to a machine learning model, such as an LLM. The model may be configured to receive the feedback and/or the candidate structured language query as inputs and output an updated candidate structured language query. In some embodiments, the feedback may be added to the knowledge set.

In some embodiments, the candidate structured language query may be updated iteratively until a correct query is generated (e.g., the feedback does not indicate any errors or deficiencies) and/or a maximum number of iterations is achieved. In some embodiments, the candidate structured language query may be updated each time new feedback is provided.

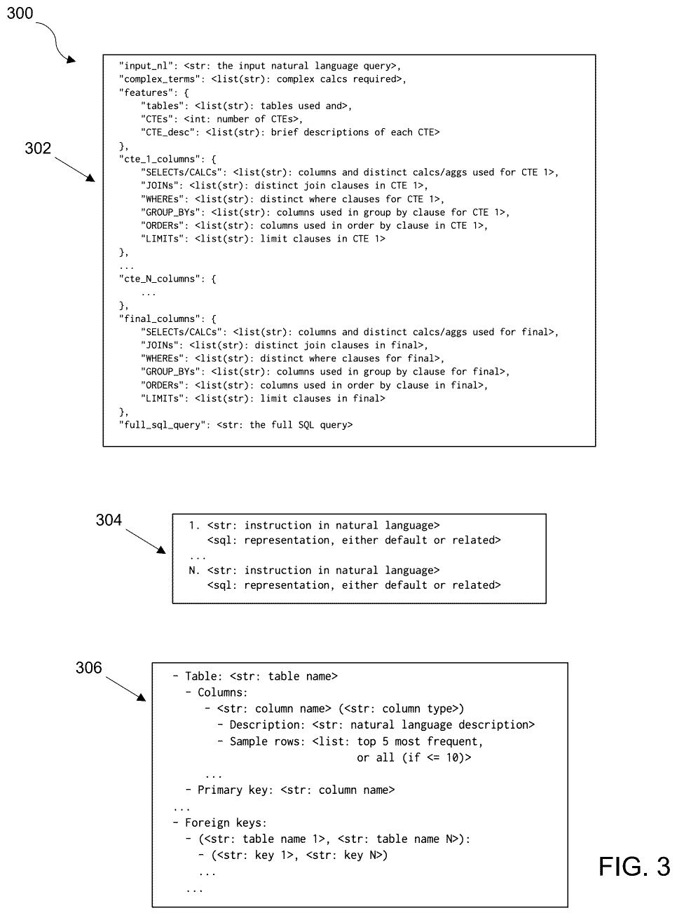

FIG. 3 illustrates a knowledge set 300 for end-to-end structured language query generation in accordance with one embodiment. As described above, the knowledge set 300 may be a structured set of contextual information for generating structured language queries. As shown, the knowledge set 300 may include sub-expressions 302, generation instructions 304, and a schema representation 306.

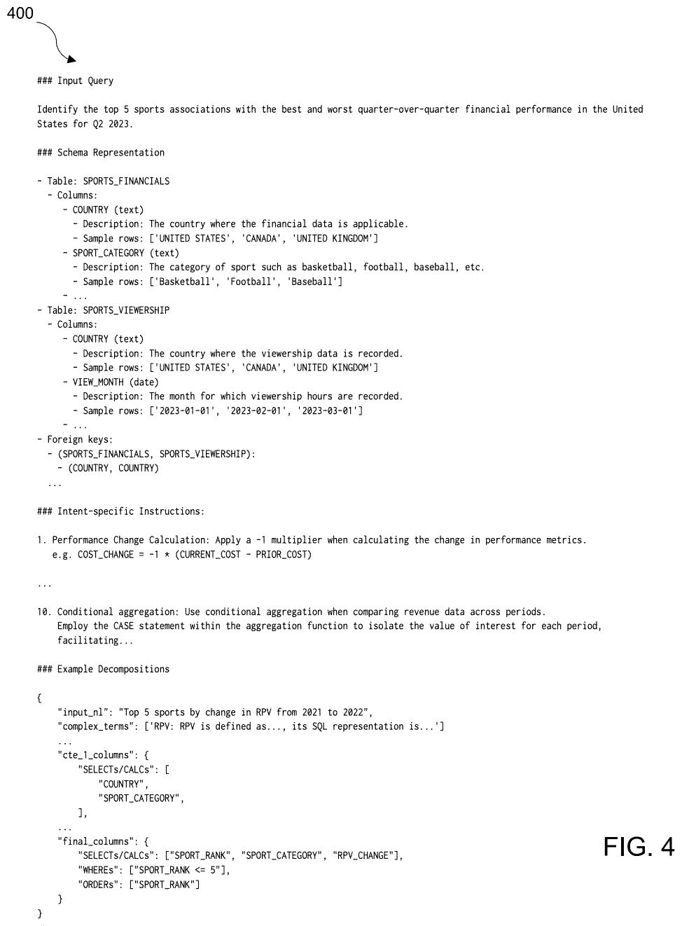

FIG. 4 illustrates a command-line interface 400 for end-to-end structured language query generation in accordance with one embodiment. As shown, the interface 400 may receive an input query as input from a user for generating a structured language query. The interface 400 may present data relevant to the input query from a knowledge set, such as a relevant schema representation, relevant intent-specific generation instructions, and relevant example decompositions forming sub-expressions.

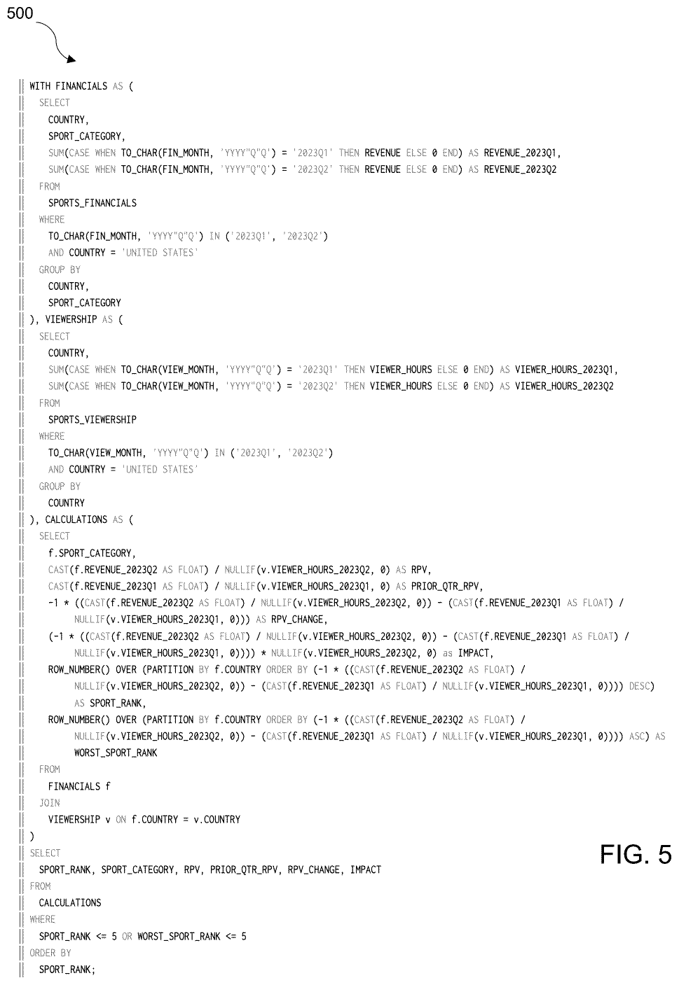

FIG. 5 illustrates a structured language query 500 in accordance with one embodiment. The structured language query 500 may be generated from a natural language query and data from a knowledge set, such as the input query, schema representation, intent-specific generation instructions, and example decompositions shown in FIG. 4. The structured language query 500 may presented to a user at a user interface, such as the command-line interface 400.

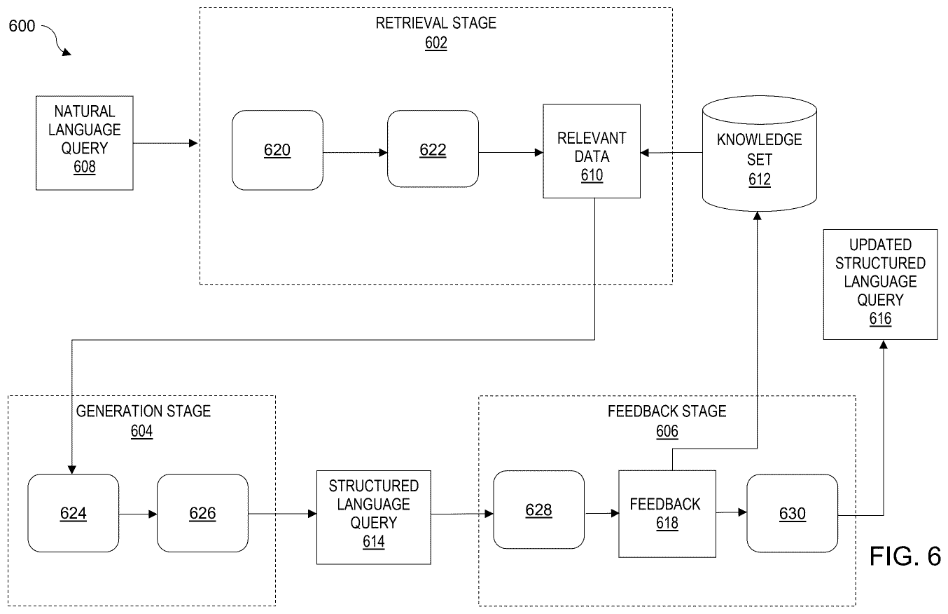

FIG. 6 illustrates a multi-stage pipeline 600 for end-to-end structured language query generation in accordance with one embodiment. The pipeline 600 may be implemented by any of the systems and/or components described herein, such as the system 100. The pipeline 600 may be configured to execute any of the operations described herein, such as the operations 202 to 210.

As shown, the pipeline 600 may include a retrieval stage 602, a generation stage 604, and a feedback stage 606. The retrieval stage 602 may receive a natural language query 608 as input and retrieve relevant data 610 from a knowledge set 612. The retrieval stage 602 may include a query reformatting operation 620 and an intent classification operation 622. At the query reformatting operation 620, the pipeline 600 may reformat the natural language query 608. At the intent classification operation 622, the pipeline 600 may classify the user intent of the natural language query 608 and retrieve the relevant data 610 based on the user intent.

The generation stage 604 may receive the relevant data 610 as input and generate a structured language query 614 as output. The generation stage 604 may include a reasoning plan generation operation 624 and a structured language query generation operation 626. At the reasoning plan generation operation 624, the pipeline 600 may generate a reasoning plan for generating the structured language query 614 based on the natural language query 608 and the relevant data 610. At the structured language query generation operation 626, the pipeline 600 may generate the structured language query 614.

The feedback stage 606 may receive the structured language query 614 and feedback 618 as inputs and output an updated structured language query 616. The feedback stage 606 may include an execution feedback operation 628 and a query update operation 630. At the execution feedback operation 628, the pipeline 600 may generate the feedback 618 (e.g., using model-based assessments). The feedback 618 may be related to the execution of the structured language query 614. At the query update operation 630, the pipeline 600 may generate the updated structured language query 616 based on the feedback 618 and the structured language query 614. The feedback 618 may be stored at the knowledge set 612 for future updates.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A computer-implemented method for structured language query generation, comprising:
generating a knowledge set based on at least one query log and at least one domain-specific document;
receiving a natural language query for a database;
retrieving data relevant to the natural language query from the knowledge set;
generating, based on the relevant data and the natural language query, a candidate structured language query using a machine learning model; and
presenting the candidate structured language query for execution against the database.

2. The computer-implemented method of claim 1, wherein the candidate structured language query comprises a SQL query.

3. The computer-implemented method of claim 1, wherein the knowledge set comprises generation instructions, sub-expressions representing structured language queries at the query log, and a schema representation indicating the structure of the database.

4. The computer-implemented method of claim 3, wherein the generating the knowledge set comprises:
retrieving the structured language queries from the query log;
reformatting the structured language queries into a sketch based on common table expressions; and
decomposing the sketch into sub-queries; and
generating the sub-expressions based on the sub-queries.

5. The computer-implemented method of claim 3, wherein the generation instructions and sub-expressions are partitioned in the knowledge set according to user intent.

6. The computer-implemented method of claim 3, wherein the schema representation indicates the structure of the database using at least one of a table name, column name, column type, or column data sample.

7. The computer-implemented method of claim 3, wherein the retrieving the relevant data comprises:
reformatting the natural language query in a canonical form;
identifying a user intent of the natural language query;
identifying relevant generation instructions and sub-expressions from the knowledge set based on the user intent; and
identifying irrelevant elements of the schema representation using a second machine learning model.

8. The computer-implemented method of claim 1, wherein the generating the candidate structured language query comprises constructing, based on the natural language query and the relevant data, a chain-of-thought reasoning plan comprising at least one pseudo-SQL statement.

9. The computer-implemented method of claim 1, wherein the machine learning model comprises a large language model configured to receive the natural language query and the relevant data as input.

10. The computer-implemented method of claim 1, further comprising:
receiving feedback regarding the execution of the candidate structured language query; and
updating the knowledge set based on the feedback; and
updating the candidate structured language query based on the updated knowledge set.

11. The computer-implemented method of claim 10, wherein the feedback comprises at least one of user feedback or feedback from an evaluation model.

12. A system for structured language query generation, comprising:
memory storing instructions; and
a processor executing the instructions to perform the steps of:
generating a knowledge set based on at least one query log and at least one domain-specific document;
receiving a natural language query for a database;
retrieving data relevant to the natural language query from the knowledge set;
generating, based on the relevant data and the natural language query, a candidate structured language query using a machine learning model; and
presenting the candidate structured language query for execution against the database.

13. The system of claim 12, wherein the candidate structured language query comprises a SQL query.

14. The system of claim 12, wherein the knowledge set comprises generation instructions, sub-expressions representing structured language queries at the query log, and a schema representation indicating the structure of the database.

15. The system of claim 14, wherein the generating the knowledge set comprises:
retrieving the structured language queries from the query log;
reformatting the structured language queries into a sketch based on common table expressions; and
decomposing the sketch into sub-queries; and
generating the sub-expressions based on the sub-queries.

16. The system of claim 14, wherein the retrieving the relevant data comprises:
reformatting the natural language query in a canonical form;
identifying a user intent of the natural language query;
identifying relevant generation instructions and sub-expressions from the knowledge set based on the user intent; and
identifying irrelevant elements of the schema representation using a second machine learning model.

17. The system of claim 12, wherein the generating the candidate structured language query comprises constructing, based on the natural language query and the relevant data, a chain-of-thought reasoning plan comprising at least one pseudo-SQL statement.

18. The system of claim 12, wherein the machine learning model comprises a large language model configured to receive the natural language query and the relevant data as input.

19. The system of claim 12, wherein the processor is further configured to perform the steps of:
receiving feedback regarding the execution of the candidate structured language query; and
updating the knowledge set based on the feedback; and
updating the candidate structured language query based on the updated knowledge set.

20. A computer program product embodied in a non-transitory computer readable storage medium and comprising computer instructions for:
generating a knowledge set based on at least one query log and at least one domain-specific document;
receiving a natural language query for a database;
retrieving data relevant to the natural language query from the knowledge set;
generating, based on the relevant data and the natural language query, a candidate structured language query using a machine learning model; and
presenting the candidate structured language query for execution against the database.
